(19) United States
(12) Patent Application Publication
(10) Pub. No.: US 2026/0305667 A1
(43) Pub. Date: Oct. 8, 2026

(54) A GEL-BALL AND PROCESS OF MANUFACTURING THE SAME AND USE THEREOF

(71) Applicant: Cargill, incorporated, Wayzata, MN (US)

(72) Inventors: Zhaolin HAO, Beijing (CN); Ruijie LI, Shanghai (CN); Ying ZHAO, Beijing (CN); Jinjin ZHOU, Shanghai (CN); Xiaoyan ZONG, Beijing (CN)

(73) Assignee: Cargill, incorporated, Wayzata, MN (US)

(21) Appl. No.: 19/485,041

(22) PCT Filed: May 23, 2024
(86) PCT No.: PCT/CN2024/094838

§ 371 Date: Nov. 17, 2025

(30) Foreign Application Priority Data
May 23, 2023 (CN) 202310591316.1
Jan. 18, 2024 (CN) 202410078180.9

(51) Int. Cl. A23L 29/256; A23L 27/00; A23P 10/30

(52) U.S. Cl. CPC A23L 29/256; A23L 27/72; A23P 10/30

(57) ABSTRACT

A gel-ball suitable to be added to food, feed, beverage, cosmetic or pharmaceutical products includes: a core comprising a core gel network comprising a gelling agent, an alginate salt and a humectant; and a surface comprising a surface gel network comprising calcium alginate, wherein the core gel network and the surface gel network intermingle with each other at the junction between the core and the surface. The gel-ball is cold-resistant.

### CROSS-REFERENCE TO RELATED APPLICATIONS

This application claims the benefit of Chinese Patent Application No. 202310591316.1, filed May 23, 2023, Chinese Patent Application No. 202410078180.9, filed Jan. 18, 2024, each which are incorporated by reference herein in its entirety.

### FIELD OF THE INVENTION

The present invention relates to the technical field of food processing, particularly relates to a gel-ball and a preparation method thereof.

### BACKGROUND

There are many different kinds of gel-ball products on the market for being added to food, feed, beverage, cosmetic or medicine to enhance their layering texture or taste.

There are some crystal ball products with blasting mouthfeel on the market. For example, Chinese patent CN108208765A discloses an alginate crystal ball and a preparation method thereof, wherein the alginate crystal ball consists of a crystal ball shell and a crystal ball core wrapped in the crystal ball shell. However, the inner core of this alginate crystal ball products with blasting mouthfeel is not a solid but a liquid or liquid with a high consistency, which cannot provide the texture and mouthfeel of a gel-ball of which both the inner and outer layers are solid.

Chinese patent CN112841612A discloses a kanten crystal ball and a preparation method thereof. The kanten crystal ball is in a single-layer agar structure.

There are no suitable cold resistant gel-balls in the market that can provide good appearance, texture and mouthfeel. Therefore, there is a need in the market to provide gel-balls that can be used in frozen applications.

### SUMMARY

The present invention provides a frozen rounded object preferably a frozen gel-ball suitable to be added to food, feed, beverage, cosmetic or pharmaceutical products, comprising a gelling agent, an alginate salt, a humectant, and a first sugar. Preferably, the frozen rounded object is cold-resistant. Preferably, the frozen rounded object is chewy and/or elastic at temperatures below 0° C.

The present invention provides a frozen rounded object preferably a frozen gel-ball suitable to be added to food, feed, beverage, cosmetic or pharmaceutical products, comprising: a core comprising a core gel network comprising a gelling agent, an alginate salt and a humectant; and a surface comprising a surface gel network comprising calcium alginate,
wherein the core gel network and the surface gel network intermingle with each other at the junction between the core and the surface. Preferably, the frozen rounded object is cold-resistant. Preferably, the frozen rounded object is chewy and/or elastic at temperatures below 0° C.

The present invention provides a process of manufacturing a frozen rounded object preferably a frozen gel-ball suitable to be added to food, feed, beverage, cosmetic or pharmaceutical products, wherein the process includes: providing a first mixture that includes 0.05-1 wt % of an alginate salt, 0.01-2 wt % of a gelling agent, 0.01-2 wt % of a humectant, 0.01-1 wt % of a potassium salt, 0-60 wt %, preferably 10-60 wt % of a first sugar, and 34-95 wt % of water; heating the first mixture to 60-95° C., preferably 80-95° C. and maintaining the temperature of the first mixture; providing a second mixture that includes 0.1-5 wt % of a calcium salt, 0-10 wt % of the first sugar, and 85-95 wt % of water; heating the second mixture to 50-95° C., preferably 70-90° C. and maintaining the temperature of the second mixture; adding the first mixture with the temperature of 60-95° C., preferably 80-95° C. maintained to the second mixture with the temperature of 50-95° C., preferably 70-90° C. maintained drop by drop to shape up a ball, filtering the ball to obtain the gel-ball, and freezing the gel-ball to obtain the frozen gel-ball, wherein the first sugar in the first mixture and the first sugar in the second mixture are not zero at the same time.

The present invention provides a frozen rounded object preferably a frozen gel-ball obtained by the process discussed. Preferably, the frozen rounded object is cold-resistant. Preferably, the frozen rounded object is chewy and/or elastic at temperatures below 0° C.

The present invention provides use of the rounded object preferably the gel-ball discussed in frozen application. The present invention also provides use of the frozen rounded object (preferably the frozen gel-ball) discussed in food, feed, beverage, cosmetic or pharmaceutical products, preferably in cold food or cold beverage. Preferably, the frozen rounded object is cold-resistant. Preferably, the frozen rounded object is chewy and/or elastic at temperatures below 0° C.

In one aspect, the frozen rounded object according to the present invention can be a frozen gel-ball. In one aspect, the rounded object preferably a gel-ball according to the present invention is a solid (e.g. not flowable under room temperature). In one aspect, the rounded object preferably a gel-ball according to the present invention is elastic. In one aspect, the rounded object according to the present invention is a heat-resistant gel-ball, e.g. it can tolerate a temperature of up to 95-121° C. In one aspect, the rounded object preferably the gel-ball is also cold-resistant, and can tolerate a temperature of 0° C. to −50° C., or from −10° C. to −20° C., or from 0° C. to −10° C., or from −12° C. to −18° C.

### BRIEF DESCRIPTION OF THE DRAWINGS

FIG. 1 is a schematic drawing of the cross section of the gel-ball of the present invention, illustrating that the gel-ball 100 has a surface 102 and a core 104. The dash line in FIG. 1 represents the junction between the surface 102 and the core 104, which indicates that there is no distinct boundary between the surface 102 and the core 104.

FIG. 2A is a photograph showing the appearance of the gel-ball of Example 1 before sterilization, illustrating that the gel-ball 200 has a surface 202 and a core 204 before sterilization.

FIG. 2B is a photograph showing the appearance of the gel-ball of Example 1 after sterilization, illustrating that the gel-ball 210 maintains a ball-shape after sterilization.

FIG. 3A is a photograph showing the appearance of the gel-ball of Example 2 before sterilization, illustrating that the gel-ball 300 has a surface 302 and a core 304 before sterilization.

FIG. 3B is a photograph showing the appearance of the gel-ball of Example 2 after sterilization, illustrating that the gel-ball 310 maintains a ball-shape after sterilization.

FIG. 4A is a photograph showing the appearance of the gel-ball of Example 3 before sterilization, illustrating that the gel-ball 400 has a surface 402 and a core 404 before sterilization.

FIG. 4B is a photograph showing the appearance of the gel-ball of Example 3 after sterilization, illustrating that the gel-ball 410 maintains a ball-shape after sterilization.

FIG. 5A is a photograph showing the appearance of the gel-ball 500 of Comparative Example 2 before sterilization.

FIG. 5B is a photograph showing the appearance of Comparative Example 2 after sterilization, illustrating that the gel-ball has melted after sterilization.

FIG. 6A is a photograph showing the appearance of the gel-ball 600 of Comparative Example 3 before sterilization.

FIG. 6B is a photograph showing the appearance of the gel-ball of Comparative Example 3 after sterilization, illustrating that the gel-balls 610 integrate into a big chunk and cannot be separated after sterilization.

FIG. 7A is a photograph of gel-ball 4 before frozen.

FIG. 7B is a photograph of frozen gel-ball 4.

FIG. 7C is a photograph of gel-ball 5 before frozen.

FIG. 7D is a photograph of frozen gel-ball 5.

FIG. 7E is a photograph of gel-ball 6 before frozen.

FIG. 7F is a photograph of frozen gel-ball 6.

FIG. 7G is a photograph of tapioca balls before frozen.

FIG. 7H is a photograph of tapioca balls after frozen.

### DETAILED DESCRIPTION

Unless otherwise noted, all measurements, weights, lengths etc. are in metric units, and all temperatures are in degrees Celsius. It is understood that unless otherwise specifically noted, the materials compounds, chemicals, etc. described herein are typically commodity items and/or industry-standard items available from a variety of suppliers and sources worldwide.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1-5%” should be interpreted to include not just about 0.1 to about 5%, but also the individual values (e g. 1%, 2%, 3% and 4%) and the sub-ranges (e.g. 0.1%-0.5%, 1.1%-2.2%, 3.3%-4.4%) within the indicated range. And for example, “95-121° C.” not only includes 95-121° C. but also the individual values (e g. 95° C., 96° C., 97° C., etc.) and the sub-ranges (e.g. 95-97° C., 96-100° C., 100-121° C.) within the indicated range. The statement “about X to Y” has the same meaning as “about X to about Y”, unless indicated otherwise. Likewise, the statement “about X, Y or about Z” has the same meaning as “about X, about Y or about Z”, unless indicated otherwise.

As used herein, the singular forms “a,” “an,” and “the” include plural referents unless the context clearly dictates otherwise. For example, reference to “a substituent” encompasses a single substituent as well as two or more substituents, and the like. It is understood that any term in the singular may include its plural counterpart and vice versa.

The term “or” is used to refer to a nonexclusive “or” unless otherwise indicated. The statement “at least one of A and B” has the same meaning as “A, B, or A and B.”

Unless otherwise specified, as used herein, the term “substantially” refers to mostly or predominantly, for example at least 50%, 60%, 70%, 80%, 90%, 95%, 96%, 97%, 98%, 99%, 99.5%, 99.9% or more.

As used herein, the terms “for example, “for instance,” “such as,” “e.g.”, or “including” are meant to introduce examples that further clarify more general subject matter. Unless otherwise specified, these examples are provided only as an aid for understanding the applications illustrated in the present disclosure, and are not meant to be limiting in any fashion.

The term “about” as used herein can allow for a degree of variability in a value or range, for example, within 10%, within 9%, within 8%, within 7%, within 6%, within 5%, within 4%, within 3%, within 2%, or within 1% of a stated value or of a stated limit of a range, and includes the exact stated value or range.

### Gel-Ball

The term “gel-ball” as used herein relates to a rounded object that is solid and soft. The gel-ball is elastic with a gelatinous or slippery texture. The gel-ball has an elastic structure. The gel-ball disclosed herein is heat-resistant as well as cold-resistant.

The term “elastic” as used herein relates to a property of a gel-ball to deform or elongate under an applied external force, and to return substantially to its original shape or length when the external force is removed. It will be understood that the applied external force is not sufficient to destroy the gel-ball but is only sufficient to deform or elongate the gel-ball.

The term “chewy” as used herein relates to a property of a gel-ball to be masticable, e.g., deform or elongate under an applied external force in the jaw of a consumer.

In one aspect, the present invention relates to a rounded object preferably a gel-ball suitable to be added to food, feed, beverage, cosmetic or pharmaceutical products, comprising: a core comprising a core gel network comprising a gelling agent, an alginate salt and a humectant; and a surface comprising a surface gel network comprising calcium alginate, wherein the core gel network and the surface gel network intermingle with each other at the junction between the core and the surface.

In one aspect, the surface of the rounded object preferably a gel-ball according to the present invention comprises a surface gel network comprising calcium alginate. In one aspect, the core and the surface of the rounded object preferably a gel-ball according to the present invention are inseparable. There is no distinct demarcation between the surface and the core of the gel-ball unlike a double-layered gel-ball.

In one aspect, the rounded object according to the present invention is a gel-ball. In one aspect, the gel-ball is in round-shaped, oblate-shaped, oblong-shaped, oval-shaped, heart-shaped, egg-shaped, obovate-shaped, etc. In one aspect, the core gel network and the surface gel network intermingle with each other at the junction between the core and the surface forming a tenon-and-mortise structure. For example, FIG. 1 shows a gel ball 100 that includes a surface 102 and a core 104, wherein the surface 102 comprises a surface gel network comprising calcium alginate, while the core 104 comprises a core gel network of comprising a gelling agent, an alginate salt and a humectant. The dash line in FIG. 1 represents the junction between the surface 102 and the core 104, which indicates that there is no distinct boundary between the surface 102 and the core 104. In one aspect, the rounded object preferably a gel-ball is a solid (e.g. in a non-flowable state). In one aspect, the rounded object preferably a gel-ball is elastic. In one aspect, elasticity refers to the property of a gel-ball, surface, or core to deform or elongate under an applied external force, and to return substantially to its original shape or length when the external force is removed.

In one aspect, the rounded object preferably a gel-ball according to the present invention is heat-resistant, for example, the rounded object preferably a gel-ball is resistant to a temperature of about 80-121° C. In one aspect, the gel-ball maintains integrity when exposed to a temperature of about 80-121° C., preferably about 85-121° C., more preferably about 90-121° C., or more preferably about 95-121° C. for about 5 to 30 minutes, preferably about 5-20 minutes, or more preferably about 5 to 15 minutes. In one aspect, heat-resistance refers to the ability to substantially maintain its original properties, including shape, texture, elasticity, and/or mouthfeel, etc. under heating conditions, e.g. at a temperature of 95-121° C. In one aspect, the rounded object preferably a gel-ball is cold resistant and can be used in cold food and/or beverages. In one aspect, the rounded object preferably a gel-ball is both heat resistant and cold resistant.

“Maintaining integrity” described herein means that the overall structure of the rounded object, preferably a gel-ball remains the same or substantially the same before and after it is exposed to external force and/or conditions, e.g. heat or freeze.

In one aspect, the rounded object, preferably a gel-ball according to the present invention is cold-resistant. The term “cold resistant” means that the gel-balls exhibit chewy and/or elastic properties at cold temperatures, e.g. below 0° C., or from 0° C. to −50° C., or from −10° C. to −20° C., or from 0° C. to −10° C., or from −12° C. to −18° C. In one aspect, the frozen gel balls do not have to be thawed prior to use in frozen application. The gel balls are consumed in the frozen food without thawing and are still substantially elastic and chewy at cold temperatures.

The cold-resistant, as well as heat-resistant gel-balls of the present invention can be used in frozen applications. The inventors also discovered that all alginate gel-balls are cold resistant and thus can be used in frozen applications.

In one aspect, the rounded object preferably a gel-ball according to the present invention is substantially spherical such as round-shaped, oblate-shaped, oblong-shaped, oval-shaped, heart-shaped, egg-shaped, obovate-shaped, etc.

In one aspect, the core or the gel-ball comprises a gelling agent. In one aspect, a gelling agent is an additional substance that can gradually transform a latex into a uniform semi-rigid solid gel and maintain its original shape. In one aspect, the gelling agent includes gelatin, carrageenan, xanthan gum, agar, gellan gum, pectin, locust bean gum, konjac flour, curdlan gum, and the combination thereof. In a preferred aspect, the gelling agent is carrageenan.

In one aspect, the core or the gel-ball comprises a humectant. In one aspect, humectant is a hygroscopic (water-absorbing) substance. Humectant is a surfactant that can allow a solid material to be more easily wetted by water through reducing its surface energy. In one aspect, the humectant includes, for example, konjac, honey, glucose syrup, glycerin, ovalbumin, soy protein isolates, xanthan gum, sodium carboxymethyl cellulose, locust bean gum, and the combination thereof. In a preferred aspect, the humectant is konjac.

In one aspect, the core or the gel-ball comprises an alginate salt. In one aspect, suitable alginate salts described herein includes sodium alginate, potassium alginate, calcium alginate. In a preferred aspect, the alginate salt is sodium alginate.

In one aspect, the core or the gel-ball further comprises a potassium salt. In one aspect, suitable potassium salt described herein includes water soluble potassium salts. Suitable potassium salts include potassium nitrate, potassium chloride, potassium citrate, potassium sulfate, potassium carbonate, potassium phosphate, etc. and a hydrate thereof, and a mixture thereof. In a preferred aspect, the potassium salt is potassium chloride or potassium citrate.

In one aspect, the core or the gel-ball further comprises a calcium salt. In one aspect, the calcium salt in the core includes water soluble calcium salts. Suitable water soluble calcium salts include those selected from the group consisting of calcium acetate, calcium benzoate, calcium bromate, calcium bromide, calcium chlorate, calcium chloride, calcium chromate, calcium dihydrogen phosphate, calcium dithionate, calcium formate, calcium gluconate, calcium glycerophosphate, calcium hydrogen sulfide, calcium iodide, calcium lactate, calcium metasilicate, calcium nitrate, calcium nitrite, calcium pantothenate, calcium perchlorate, calcium permanganate, calcium phosphate, calcium phosphinate, calcium salicylate, calcium succinate, a hydrate thereof, and a mixture thereof. In one aspect, calcium salts can be provided as hydrated compounds or anhydrous compounds. In a preferred aspect, calcium salt is calcium lactate or calcium chloride.

In one aspect, the core or the gel-ball further comprises a first sugar. In one aspect, suitable sugar described herein includes but not limited to cane sugar (e.g. from cane or beet), glucose, fructose, lactose, maltose, glucose syrup, fructose and glucose syrup, corn syrup, invert sugar, honey, maple syrup, brown sugar, molasses and the combination thereof. In a preferred aspect, the first sugar is cane sugar.

In one aspect, the gel-ball comprises a first sugar, and the first sugar is distributed in the core, or the surface or a combination thereof. In one aspect, the first sugar comprises cane sugar, glucose, fructose, lactose, maltose, glucose syrup, fructose and glucose syrup, corn syrup, invert sugar, honey, maple syrup, brown sugar, molasses or any combination thereof. In a preferred aspect, the first sugar is cane sugar, and fructose and glucose syrup.

In one aspect, in addition to calcium alginate, the surface may also include the gelling agent, the humectant, another alginate salt, the potassium salt, another calcium salt (not calcium alginate), and/or the first sugar which exist in the core as described herein. However, the content of these components in the surface is lower than that in the core as a larger amount of these components accumulate in the core during the process of manufacturing the gel-ball.

In one aspect, the content of calcium alginate in the surface is higher than that in the core. In one aspect, the content of calcium alginate gradually decreases from the surface to the junction between the surface and the core. In one aspect, the surface and the core are in a tenon-and-mortise structure.

In one aspect, the rounded object preferably a gel-ball according to the present invention further comprises an acid regulator and/or a second sugar. In one aspect, the acid regulator and/or the second sugar penetrates the surface and core and is dispersed throughout the rounded object preferably the gel-ball. The acid regulator and/or the second sugar may also be present only in the core or only on the surface.

In one aspect, the acid regulator is an additive that is used to adjust or maintain the pH value (acidity or alkalinity). In one aspect, the acid regulator can be organic acid or inorganic acid, alkali, neutralizer or buffer. In one aspect, suitable acid regulator described herein includes ascorbic acid, phosphoric acid, tartaric acid, lactic acid, citric acid, malic acid, sodium citrate and the combination thereof. In a preferred aspect, acid regulator is citric acid.

In one aspect, the second sugar described herein includes but not limited to cane sugar (e.g. from cane or beet), glucose, fructose, lactose, maltose, glucose syrup, fructose and glucose syrup, corn syrup, invert sugar, honey, maple syrup, brown sugar, molasses and any combination thereof. In a preferred aspect, the second sugar contains cane sugar and/or fructose and glucose syrup.

In one aspect, the acid regulator and/or second sugar is present in an amount sufficient to provide a Brix value of about 20 to 60%, preferably about 30 to 50%, more preferably about 40 to 45%. In one aspect, the acid regulator is present in an amount sufficient to provide a pH value of about 3.0 to 5.0, preferably about 3.5 to 4.2.

In one aspect, the rounded object preferably a gel-ball has a radius that is suitable to be added in food, feed, beverage, cosmetic or pharmaceutical products, for example, about 2-20 mm, preferably about 2.5-12 mm, or more preferably about 2.5-6 mm.

The diameter of the rounded object preferably a gel-ball can vary and can be dependent on the end use. In one aspect, the gel-ball for Boba tea comprises a diameter between about 2 mm and about 20 mm, preferably about 2 mm and about 10 mm, more preferable between about 5 mm and 8 mm, more preferably about 8 mm.

In one aspect, the present invention relates to a process of manufacturing a rounded object preferably a gel-ball suitable to be added to food, feed, beverage, cosmetic or pharmaceutical products, wherein the process includes:
providing a first mixture that includes 0.05-1 wt % of an alginate salt, 0.01-2 wt % of a gelling agent, 0.01-2 wt % of a humectant, 0.01-1 wt % of a potassium salt, and 80-95 wt % of water;
heating the first mixture to 60-95° C., preferably 80-95° C. and maintaining the temperature of the first mixture;
providing a second mixture that includes 0.1-5 wt % of a calcium salt, 1-10 wt % of a first sugar, and 85-95 wt % of water;
heating the second mixture to 50-95° C., preferably 70-90° C. and maintaining the temperature of the second mixture;
adding the first mixture with the temperature of 60-95° C., preferably 80-95° C. maintained to the second mixture with the temperature of 50-95° C., preferably 70-90° C. maintained drop by drop to shape up a ball, and
filtering the ball to obtain the gel-ball.

In one aspect, the present invention provides a process of manufacturing a gel-ball suitable to be added to food, feed, beverage, cosmetic or pharmaceutical products, wherein the process includes:
providing a first mixture that includes 0.05-1 wt % of an alginate salt, 0.01-2 wt % of a gelling agent, 0.01-2 wt % of a humectant, 0.01-1 wt % of a potassium salt, 0-60 wt %, preferably 10-60 wt % of a first sugar, and 34-95 wt % of water;
heating the first mixture to 60-95° C., preferably 80-95° C. and maintaining the temperature of the first mixture;
providing a second mixture that includes 0.1-5 wt % of a calcium salt, 0-10 wt % of a first sugar, and 85-95 wt % of water;
heating the second mixture to 50-95° C., preferably 70-90° C. and maintaining the temperature of the second mixture;
adding the first mixture with the temperature of 60-95° C., preferably 80-95° C. maintained to the second mixture with the temperature of 50-95° C., preferably 70-90° C. maintained drop by drop to shape up a ball, and
filtering the ball to obtain the gel-ball.

In one aspect, the first mixture comprises a first sugar describe herein. In one aspect, the first mixture includes 0-60 wt %, or preferably 10-60 wt %, or more preferably 10-55 wt % of the first sugar. In one aspect, the first sugar comprises cane sugar, glucose, fructose, lactose, maltose, glucose syrup, fructose and glucose syrup, corn syrup, invert sugar, honey, maple syrup, brown sugar, molasses or any combination thereof.

In one aspect, the first sugar in the first mixture and the first sugar in the second mixture are not zero at the same time. In one aspect, in addition to the first sugar, the second mixture may further include other suitable sugars as described. In one aspect, the second mixture includes zero of the first sugar, but includes other suitable sugars as described, which makes the first mixture and the second mixture include different sugars. In one aspect, the other suitable sugars are selected from the group of the first sugar. In one aspect, the first mixture and the second mixture include different kinds of the first sugars.

In one aspect, the first mixture comprises an alginate salt (excluding calcium alginate) described herein. In one aspect, the first mixture includes about 0.05-1 wt %, preferably about 0.05-0.5 wt %, more preferably about 0.2-0.9 wt %, more preferably about 0.2-0.5 wt %, more preferably about 0.5-0.9 wt %, or more preferably about 0.5-1 wt % of alginate salt, such as sodium alginate, based on the weight of the first mixture.

In one aspect, the first mixture comprises a gelling agent described herein. In one aspect, the first mixture includes about 0.01-2 wt %, preferably about 0.05-2 wt %, more preferably about 0.1-2 wt %, more preferably about 0.01-1 wt %, more preferably about 0.25-1 wt %, more preferably about 0.25-0.5 wt %, more preferably about 0.5-1 wt %, or more preferably about 0.1-0.5 wt % of gelling agent, such as carrageenan, based on the weight of the first mixture.

In one aspect, the first mixture comprises a humectant described herein. In one aspect, the first mixture includes about 0.01-2 wt %, preferably about 0.05-2 wt %, more preferably about 0.1-2 wt %, more preferably about 0.01-1 wt %, more preferably about 0.25-0.8 wt %, more preferably about 0.05-0.5 wt %, more preferably about 1-2 wt %, or more preferably about 0.1-0.5 wt % of humectant, such as konjac, based on the weight of the first mixture.

In one aspect, the first mixture comprises a potassium salt described herein. In one aspect, the first mixture includes about 0.01-1 wt %, preferably about 0.05-1 wt %, more preferably about 0.01-0.5 wt %, more preferably about 0.05-0.5 wt %, more preferably about 0.2-1 wt %, more preferably about 0.2-0.4 wt %, more preferably about 0.4-1 wt %, or more preferably about 0.5-1 wt % of potassium salt, such as potassium chloride or potassium citrate, based on the weight of the first mixture.

In one aspect, the first mixture comprises water. In one aspect, the second mixture comprises water till the percentage of all components is 100%. In one aspect, the first mixture includes about 80-95 wt %, preferably about 65-99 wt %, more preferably about 70-99 wt %, more preferably about 80-99 wt %, more preferably about 90-99 wt %, more preferably about 60-95 wt %, more preferably about 65-95 wt %, more preferably about 75-95 wt %, more preferably about 80-95 wt %, more preferably about 60-90 wt %, more preferably about 65-90 wt %, more preferably about 70-90 wt %, more preferably about 75-90 wt %, more preferably about 80-90 wt %, more preferably about 96.3-99.1 wt %, more preferably about 96.3-97.8 wt %, more preferably about 97.8-99.1 wt %, or more preferably about 85-90 wt % of water, based on the weight of the first mixture.

In one aspect, the second mixture comprises a calcium salt described herein. In one aspect, the second mixture includes about 0.1-5 wt %, preferably about 0.1-4 wt %, more preferably about 0.1-3 wt %, more preferably about 0.1-2 wt %, more preferably about 0.1-1 wt %, more preferably about 0.5-1 wt %, more preferably about 0.5-5 wt %, more preferably about 0.5-4 wt %, more preferably about 0.5-5 wt %, more preferably about 0.5-3 wt %, more preferably about 2.5-5 wt %, or more preferably about 3-5 wt % of calcium salt, such as calcium lactate or calcium chloride, based on the weight of the second mixture.

In one aspect, the second mixture comprises a first sugar described herein. In one aspect, the second mixture include about 0-10 wt %, or 1-10 wt %, preferably about 1-9 wt %, more preferably about 1-8 wt %, more preferably about 1-5 wt %, more preferably about 1-4 wt %, more preferably about 1-3 wt %, more preferably about 2-10 wt %, more preferably about 3-10 wt %, or more preferably about 5-10 wt % of the first sugar, such as cane sugar, based on the weight of the second mixture.

In one aspect, the second mixture comprises water. In one aspect, the second mixture comprises water till the percentage of all components is 100%. In one aspect, the second mixture includes about 85-95 wt %, preferably about 65-99 wt %, more preferably about 70-99 wt %, more preferably about 80-99 wt %, more preferably about 90-99 wt %, more preferably about 60-95 wt %, more preferably about 65-95 wt %, more preferably about 75-95 wt %, more preferably about 80-95 wt %, more preferably about 60-90 wt %, more preferably about 65-90 wt %, more preferably about 70-90 wt %, more preferably about 75-90 wt %, more preferably about 85-89.5 wt %, more preferably about 85-87 wt %, or more preferably about 87-89.5 wt % of water, based on the weight of the second mixture.

In one aspect, the process according to the present invention includes heating the first mixture to about 60-95° C., preferably about 65-95° C., more preferably about 70-95° C., more preferably about 80-95° C., more preferably about 60-90° C., more preferably about 60-85° C., more preferably about 60-80° C., more preferably about 60-75° C., more preferably about 60-70° C., more preferably about 85-95° C., more preferably about 85-90° C., more preferably about 90-95° C., or more preferably about 80-90° C. and maintaining the temperature of the first mixture. In another aspect, the process according to the present invention includes heating the second mixture to about 50-95° C., preferably about 55-95° C., more preferably about 60-90° C., more preferably about 60-80° C., more preferably about 60-95° C., more preferably about 65-95° C., more preferably about 70-95° C., more preferably about 75-95° C., more preferably about 80-95° C., more preferably about 85-95° C., more preferably about 90-95° C., more preferably about 50-90° C., more preferably about 55-90° C., more preferably about 65-90° C., more preferably about 70-90° C., more preferably about 75-90° C., or more preferably about 80-90° C. and maintaining the temperature of the second mixture.

In one aspect, the temperature of the first mixture is maintained for more than 10 minutes before adding to the second mixture. In another aspect, the temperature of the first mixture is maintained for more than about 15 minutes, preferably about 20 minutes, more preferably about 25 minutes, more preferably about 30 minutes, more preferably about 35 minutes, or more preferably about 60 minutes before adding to the second mixture. In another aspect, the temperature of the first mixture is maintained for about 10-20 minutes, preferably about 10-25 minutes, more preferably about 10-30 minutes, more preferably about 15-35 minutes, or more preferably about 15-60 minutes before adding to the second mixture.

In one aspect, the viscosity of the first mixture is determined under a temperature of 60-95° C., preferably 80-95° C. In one aspect, the viscosity of the first mixture is about 10-120000 cP, preferably about 10-1000 cP, preferably about 10-5000 cP, or more preferably about 20000-120000 cP.

In one aspect, the first mixture is added to the second mixture by any means that can deliver the fluid drop by drop. For example, a suitable apparatus for adding the first mixture to the second mixture includes dropper, calibrated pipette, burette, drop pipette, handheld separatory funnel, etc. In one aspect, the first mixture is added to the second mixture drop by drop. The size of the drop can vary and may depend on the viscosity of the first mixture. For example, the diameter of the drop can be about 5-30 mm depending on the viscosity of the first mixture and the size of the drop pipette. In one aspect, the first mixture is added to the second mixture drop by drop at any rate or any time interval between successive drops as long as the drop from the first mixture maintains a distinct separation from one another.

In one aspect, the temperature of the second mixture is maintained for about 5-30 minutes before the first mixture is added to the second mixture. In another aspect, the temperature of the second mixture is maintained for about 0-30 minutes, preferably about 10-25 minutes, more preferably about 10-30 minutes, more preferably about 15-35 minutes, more preferably about 15-60 minutes, or more preferably maintained for about 5-10 minutes before the first mixture is added to the second mixture.

In one aspect, the ball is maintained in the second mixture at about 50-95° C., preferably about 55-95° C., more preferably about 60-95° C., more preferably about 70-95° C., more preferably about 75-95° C., more preferably about 80-95° C., more preferably about 85-95° C., or more preferably about 70-90° C. for about 1-15 minutes, preferably about 1-5 minutes, more preferably about 5-10 minutes, more preferably about 10-15 minutes, or more preferably maintained for about 1-10 minutes before the ball is filtered.

In one aspect, the process according to the present invention further comprises cooling down the filtered ball to below 40° C. In one aspect, the process according to the present invention further comprises cooling down the filtered ball to below 35° C., preferably to below 30° C., preferably to below 25° C. or preferably to below 20° C.

In one aspect, the process according to the present invention further comprises providing a third mixture that includes 0-2 wt % of an acid regulator, 48-100 wt % of a second sugar, and 0-50 wt % of water, based on the weight of the third mixture.

In one aspect, the acid regulator is an additive that is used to adjust or maintain the pH value (acidity or alkalinity). In one aspect, acid regulator can be organic acid or inorganic acid, alkali, neutralizer or buffer. In one aspect, suitable acid regulator described herein includes ascorbic acid, phosphoric acid, tartaric acid, lactic acid, citric acid, malic acid, sodium citrate and the combination thereof. In a preferred aspect, acid regulator is citric acid.

In one aspect, the second sugar described herein includes but not limited to cane sugar (e.g. from cane or beet), glucose, fructose, lactose, maltose, glucose syrup, fructose and glucose syrup, corn syrup, invert sugar, honey, maple syrup, brown sugar, molasses and the combination thereof. In a preferred aspect, the second sugar contains cane sugar and/or fructose and glucose syrup.

In one aspect, the third mixture includes an acid regulator described herein. In one aspect, the third mixture includes about 0-2 wt %, preferably about 0-1 wt %, more preferably about 0-0.5 wt %, more preferably about 0.1-5 wt %, more preferably about 0.1-2 wt %, more preferably about 0.1-1 wt %, more preferably about 0.01-1 wt %, more preferably about 0.01-2 wt %, more preferably about 1-2 wt %, or more preferably about 0.5-1 wt % of acid regulator, such as citric acid, based on the weight of the third mixture.

In one aspect, the third mixture includes a second sugar described herein. In one aspect, the third mixture includes about 48-100 wt %, preferably about 50-100 wt %, more preferably about 60-100 wt %, more preferably about 70-100 wt %, more preferably about 80-100 wt %, more preferably about 90-100 wt %, more preferably about 40-90 wt %, more preferably about 50-52 wt %, or more preferably about 50-90 wt % of sugar, such as cane sugar and/or fructose and glucose syrup, based on the weight of the third mixture. In one aspect, the second sugar includes about 1-50 wt % of cane sugar and/or about 1-80 wt % of fructose and glucose syrup. In one aspect, the second sugar includes about 5-25 wt %, preferably about 5-10 wt %, or more preferably about 10-25 wt % of cane sugar and about 25-40 wt %, preferably about 25-47 wt %, or more preferably about 40-47 wt % of fructose and glucose syrup.

In one aspect, the third mixture comprises water till the percentage of all components is 100%. In one aspect, the third mixture includes about 0-70 wt %, preferably about 0-60 wt %, more preferably about 0-50 wt %, more preferably about 0-40 wt %, more preferably about 0-30 wt %, more preferably about 0-20 wt %, more preferably about 0-10 wt %, more preferably about 10-60 wt %, more preferably about 10-50 wt %, more preferably about 10-40 wt %, more preferably about 10-30 wt %, more preferably about 10-20 wt %, more preferably about 25-50 wt %, more preferably about 25-30 wt %, more preferably about 20-50 wt %, more preferably about 46-49 wt %, more preferably about 46-49.99 wt %, about 49-49.99 wt %, or more preferably about 15-50 wt % of water, based on the weight of the third mixture.

In one aspect, the third mixture has about 40% brix value. In one aspect, the third mixture has about 20-60%, preferably about 30-60%, more preferably about 40-60%, more preferably about 50-60%, more preferably about 20-50%, more preferably about 30-50%, more preferably about 40-50%, or more preferably about 40-45% brix value. In one aspect, the third mixture has a pH value of about 3-5, preferably about 3-4.5, or more preferably about 3.5-4.2.

In one aspect, the filtered balls can be added to the third mixture together in one time. In one aspect, the third mixture penetrates the surface and core of the gel-ball and is dispersed throughout the gel-ball.

In one aspect, the rounded object preferably a gel-ball is sterilized for about 5-15 minutes at a temperature of about 95-121° C. In another aspect, the rounded object preferably a gel-ball is sterilized for about 5-30 minutes, preferably about 5-25 minutes, more preferably about 5-20 minutes, more preferably about 5-15 minutes, more preferably about 5-10 minutes, or more preferably about 10-15 minutes at a temperature of about 100-121° C., preferably about 105-121° C., more preferably about 110-121° C., more preferably about 115-121° C., more preferably about 95-120° C., more preferably about 100-120° C., more preferably about 105-120° C., more preferably about 110-120° C., or more preferably about 115-120° C.

The present invention further relates to a rounded object preferably a gel-ball obtained by the process described herein.

Without being bound by theory, the inventors of the present invention discovered that the temperature of the first mixture and the second mixture have significant effect on the properties, such as heat resistance of the rounded object preferably a gel-ball. Without being bound by theory, it is believed that when adding the first mixture drop by drop to the second mixture, heating the first mixture and maintaining it at the temperature of about 60-95° C., preferably 80-95° C.; and heating the second mixture and maintaining it at the temperature of about 50-95° C., preferably 70-90° C., it allows the rounded object preferably a gel-ball of the present invention to be heat resistant (e.g. at 95-121° C.). It is believed that when adding the first mixture containing alginate salt into the second mixture containing calcium salt, the alginate salt reacts with the calcium salt to form a surface gel network comprising calcium alginate on the surface, allowing the gel-ball as a whole to have the heat-resistant property.

### Frozen Application

The present invention provides use of the gel-ball discussed above in frozen applications. The present invention provides a frozen gel-ball, wherein the gel-ball is the gel-ball discussed above.

The inventors discovered that the heat-resistant gel-balls of the present invention are also cold-resistant and can also be used in frozen applications. The inventors also discovered that all alginate gel-balls are cold resistant and thus can be used in frozen applications.

The terms in the section “frozen application” such as “gel-ball”, “elastic”, “maintaining integrity”, “gelling agent”, “humectant”, “alginate salt”, “potassium salt”, “calcium salt”, “water soluble calcium salt”, “sugar”, “first sugar”, “second sugar”, “acid regulator”, “diameter”, “viscosity”, “a suitable apparatus for adding the first mixture to the second mixture” and so on are the same as those described in the previous section “gel-ball” if applicable.

The frozen, cold-resistant gel-balls can exhibit elasticity and chewiness at cold temperatures, e.g. below 0° C., or from 0° C. to −50° C., or from −10° C. to −20° C., or from 0° C. to −10° C., or from −12° C. to −18° C. In one aspect, the frozen gel balls do not have to be thawed prior to use in frozen application. The gel balls are consumed in the frozen food without thawing and are still elastic and/or chewy at cold temperatures.

The present invention provides a frozen gel-ball suitable to be added to food, feed, beverage, cosmetic or pharmaceutical products, comprising a gelling agent, an alginate salt, a humectant, and a first sugar.

The present invention also provides a frozen gel-ball suitable to be added to food, feed, beverage, cosmetic or pharmaceutical products, comprising: a core comprising a core gel network comprising a gelling agent, an alginate salt and a humectant; and a surface comprising a surface gel network comprising calcium alginate, wherein the core gel network and the surface gel network intermingle with each other at the junction between the core and the surface.

In one aspect, the frozen gel-ball comprises a first sugar, and the first sugar is distributed in the core, or the surface or a combination thereof. In one aspect, the first sugar is mainly distributed in the surface. In one aspect, the first sugar comprises cane sugar, glucose, fructose, lactose, maltose, glucose syrup, fructose and glucose syrup, corn syrup, invert sugar, honey, maple syrup, brown sugar, molasses or any combination thereof. In a preferred aspect, the first sugar is fructose and glucose syrup, and cane sugar.

In one aspect, the frozen gel-ball maintains integrity when exposed to a temperature of from 0° C. to −50° C., or preferably from −10° C. to −20° C., or preferably from 0° C. to −10° C., or more preferably from −12° C. to −18° C. In one aspect, the frozen gel-ball maintains elasticity and chewiness when exposed to a temperature of from 0° C. to −50° C., or from −10° C. to −20° C., or from 0° C. to −10° C., or from −12° C. to −18° C.

In one aspect, the frozen gel-ball comprises firmness, texture, elasticity, mouthfeel and/or chewiness desirable in a food product. The frozen gel-ball is chewy and has a desired texture and mouthfeel compared to a frozen tapioca ball. The gel-ball can be analyzed by a pressure test conducted on a Texture Analyser. The Texture Analyser is used in a compression/force test mode with a Pre-test speed of 0.5 mm/second. The deformation distance of a frozen gel-ball at a set force, e.g., 200N, is determined. In one aspect, the deformation distance of the frozen gel-ball is greater than the deformation distance of a frozen tapioca ball in a pressure test at 200N. The deformation distance of the frozen gel-ball described herein is greater than the deformation distance of a frozen tapioca ball by at least 1.1 fold, or at least 1.2 fold, or at least 1.3 fold, or at least 1.4 fold, or at least 1.5 fold, or at least 1.6 fold, or at least 1.7 fold, or at least 1.8 fold or at least 1.9 fold, or at least 2 fold, or at least 3 fold, or at least 4 fold, or at least 5 fold.

In one aspect, the frozen gel-ball has a deformation distance of 1-5 mm, or 1.5-3.5 mm, or 1.6-3 mm when a pressure force of 200N is conducted onto the frozen gel ball. In one aspect, the frozen gel-ball has a deformation distance of at least 1 mm in pressure test at 200N, preferably at least 2.0 mm, or preferably at least 3.0 mm.

In one aspect, the gelling agent is described above and in a preferred aspect, the gelling agent is carrageenan.

In one aspect, the humectant is described above and in a preferred aspect, the humectant is konjac.

In one aspect, the alginate salt is described above and in a preferred aspect, alginate salt is sodium alginate.

In one aspect, the gel-ball further comprises a potassium salt. In a preferred aspect, the potassium salt is potassium chloride or potassium citrate.

The present invention provides a process of manufacturing a frozen gel-ball suitable to be added to food, feed, beverage, cosmetic or pharmaceutical products, wherein the process includes:
providing a first mixture that includes 0.05-1 wt % of an alginate salt, 0.01-2 wt % of a gelling agent, 0.01-2 wt % of a humectant, 0.01-1 wt % of a potassium salt, 0-60 wt % (or preferably 10-60 wt % or more preferably 25-60 wt % or more preferably 10-55 wt %) of a first sugar, and 34-95 wt % of water;
heating the first mixture to 60-95° C., preferably 80-95° C. and maintaining the temperature of the first mixture;
providing a second mixture that includes 0.1-5 wt % of a calcium salt, 0-10 wt % (or preferably 0 wt %, or more preferably 1-5 wt % or more preferably 5-10 wt %) of a first sugar, and 85-95 wt % of water;
heating the second mixture to 50-95° C., preferably 70-90° C. and maintaining the temperature of the second mixture;
adding the first mixture with the temperature of 60-95° C., preferably 80-95° C. maintained to the second mixture with the temperature of 50-95° C., preferably 70-90° C. maintained drop by drop to shape up a ball, and
filtering the ball to obtain the gel-ball, and
freezing the gel-ball to obtain the frozen gel-ball.

In one aspect, the gel-ball is frozen to obtain the frozen gel-ball first and then the frozen gel ball is added in food, feed, beverage, cosmetic or pharmaceutical products, preferably in cold food or cold beverage. In one aspect, the gel-ball is added in food, feed, beverage, cosmetic or pharmaceutical products, preferably in cold food or cold beverage first and then frozen together with the food and beverages, etc.

In one aspect, the first sugar comprises cane sugar, glucose, fructose, lactose, maltose, glucose syrup, fructose and glucose syrup, corn syrup, invert sugar, honey, maple syrup, brown sugar, molasses or any combination thereof. In one aspect, the first sugar in the first mixture and the first sugar in the second mixture are not zero at the same time. In one aspect, in addition to the first sugar, the second mixture may further include other suitable sugars. In one aspect, the first mixture and the second mixture include different kinds of sugars.

In one aspect, the temperature of the first mixture is maintained for more than 10 minutes before adding to the second mixture. In one aspect, the temperature of the second mixture is maintained for 5-30 minutes, preferably 5-10 minutes before the first mixture is added to the second mixture. In one aspect, the ball is maintained in the second mixture at 50-95° C., preferably 70-90° C. for 1-15 minutes, preferably 1-10 minutes before the ball is filtered.

In one aspect, the calcium salt is described above and in a preferred aspect, the calcium salt is calcium lactate or calcium chloride.

In one aspect, the process further comprises providing a third mixture that includes 0-2 wt % of acid regulator, 48-100 wt % of second sugar, and 0-50 wt % of water.

In one aspect, the acid regular is described above and in a preferred aspect, the acid regulator is citric acid.

In one aspect, the second sugar comprises cane sugar, glucose, fructose, lactose, maltose, glucose syrup, fructose and glucose syrup, corn syrup, invert sugar, honey, maple syrup, brown sugar, molasses or any combination thereof. In one aspect, the second sugar contains 1-50 wt % cane sugar and/or 1-80 wt % of fructose and glucose syrup.

In one aspect, the process further comprises heating the third mixture to a temperature of 50-95° C. and maintained the temperature of the third mixture, and adding the filtered ball to the third mixture with the temperature of 50-95° C. maintained.

In one aspect, the gel-ball is sterilized for 5-15 minutes at a temperature of 95-121° C. prior to being frozen.

The present invention provides a frozen gel-ball obtained by the process discussed. In one aspect, the gel-ball obtained from the process under the section “gel-ball” is frozen to obtain a frozen gel ball of the present invention.

The present invention provides use of the gel-ball discussed in frozen application. The present invention provides use of the frozen gel-ball discussed in food, feed, beverage, cosmetic or pharmaceutical products. In one aspect, the frozen gel-ball is used in cold food or cold beverage. In one aspect, the frozen gel-ball is used in an ice cream food product.

### EXAMPLES

The following examples are presented to further illustrate and explain the present invention and should not be taken as limiting in any regard.

### Example 1

### Preparation of a Heat-Resistant Gel-Ball

A first mixture was prepared according to the ingredients in Table 1. The first mixture was heated to the indicated temperature for the indicated period in Table 1.

TABLE 1

| Ingredient | Gel-ball 1 | Gel-ball 2 | Gel-ball 3 |
|---|---|---|---|
| Sodium | 0.20% | 0.50% | 0.90% |
| alginate | | | |
| Carrageenan | 0.25% | 0.50% | 1.00% |
| Konjac flour | 0.25% | 0.80% | 0.80% |
| Potassium | 0.20% | 0.40% | 1.00% |
| chloride | | | |
| Water | 99.10% | 97.80% | 96.300% |
| Total | 100.00% | 100.00% | 100.000% |
| Temperature: | 85° C. | 90° C. | 95° C. |
| Maintain | 15 mins | 15 mins | 15 mins |
| time: | | | |

A second mixture was prepared according to the ingredients in Table 2. The second mixture was heated to the indicated temperature in Table 2.

TABLE 2

| Ingredient | Gel-ball 1 | Gel-ball 2 | Gel-ball 3 |
|---|---|---|---|
| Calcium lactate | 5% | 3% | 0.50% |
| Cane sugar | 10% | 10% | 10% |
| Water | 85.00% | 87.00% | 89.500% |
| Total | 100% | 100% | 100% |
| Temperature | 60° C. | 80° C. | 90°° C. |

The first mixture maintained at the temperature and time indicated in Table 1 was added drop by drop to the second mixture maintained at the temperature indicated in Table 2 to form gel-balls. The gel-balls stayed in the second mixture for the time indicated in Table 3. The gel-balls are then filtered.

TABLE 3

| | Gel-ball 1 | Gel-ball 2 | Gel-ball 3 |
|---|---|---|---|
| Temperature of the second | 60° C. | 80° C. | 90° C. |
| mixture | | | |
| Maintained time | 1 min | 5 mins | 10 mins |

A third mixture was prepared according to the ingredients in Table 4 (In another examples, the third mixture is not a necessary component). The filtered gel-ball was added to the third mixture. The Brix value of the third mixture is maintained at 40%.

TABLE 4

| Ingredient | Gel-ball 1 | Gel-ball 2 | Gel-ball 3 |
|---|---|---|---|
| Citric acid | 0.01% | 1% | 2% |
| Cane sugar | 25% | 10% | 5% |
| Fructose and | 25% | 40% | 47% |
| glucose syrup | | | |
| Water | 49.99% | 49% | 46% |
| Total | 100.00% | 100.00% | 100.00% |

### Comparative Examples 1-3

A first mixture was prepared according to the ingredients in Table 5. The first mixture was heated to the indicated temperature for the indicated period in Table 5.

TABLE 5

| | Comparative | Comparative | Comparative |
|---|---|---|---|
| Ingredient | Example 1 | Example 2 | Example 3 |
| Sodium | 0.00% | 0.00% | 0.50% |
| alginate | | | |
| Carrageenan | 1.00% | 1.00% | 0.40% |
| Konjac flour | 0.80% | 0.80% | 0.40% |
| Potassium | 1.00% | 1.00% | 0.40% |
| chloride | | | |
| Water | 97.200% | 97.200% | 98.300% |
| Total | 100.000% | 100.000% | 100.000% |
| Temperature | 90° C. | 90° C. | 90° C. |
| Maintain time | 15 mins | 15 mins | 15 mins |

A second mixture was prepared according to the ingredients in Table 6. The second mixture was heated to the indicated temperature in Table 6.

TABLE 6

| | Comparative | Comparative | Comparative |
|---|---|---|---|
| Ingredient | Example 1 | Example 2 | Example 3 |
| Calcium lactate | 0% | 3.00% | 3.00% |
| Cane sugar | 10% | 10% | 10% |
| Water | 90.00% | 87.00% | 87.000% |
| Total | 100% | 100% | 100% |
| Temperature | 90° C. | Room | Room |
| | | temperature | temperature |

The first mixture maintained at the temperature and time indicated in Table 5 was added drop by drop to the second mixture maintained at the temperature indicated in Table 6 to form gel-balls. The gel-balls stayed in the second mixture for the time indicated in Table 7. The gel-balls are then filtered.

TABLE 7

| | Comparative | Comparative | Comparative |
|---|---|---|---|
| | Example 1 | Example 2 | Example 3 |
| Solution | 90° C. | Room | Room |
| temperature | | temperature | temperature |
| Maintained time | 3 mins | 5 mins | 10 mins |

A third mixture was prepared according to the ingredients in Table 8. The filtered gel-ball was added to the third mixture. The Brix value of the third mixture is maintained at 40%.

TABLE 8

| | Comparative | Comparative | Comparative |
|---|---|---|---|
| Ingredient | Example 1 | Example 2 | Example 3 |
| Citric acid | 0.01% | 0.01% | 0.01% |
| cane sugar | 25% | 25% | 25% |
| Fructose and | 25% | 25% | 25% |
| glucose syrup | | | |
| Water | 49.99% | 49.99% | 49.99% |
| Total | 100.00% | 100.00% | 100.00% |

The gel-balls produced according to the present invention (i.e. Gel-ball 1, Gel-ball 2 and Gel-ball 3) and Comparative Example 1-3 were heated to 121° C. for sterilization for 15 minutes and observed. The results are shown in Table 9.

TABLE 9

| | Shape | Appearance before and after sterilization |
|---|---|---|
| Gel-ball 1 | Sphere | Can form a crystal ball with a soft |
| | | mouthfeel, remaining independent after |
| | | sterilization |
| Gel-ball 2 | Sphere | Can form a crystal ball with a chewy |
| | | mouthfeel, remaining independent after |
| | | sterilization |
| Gel-ball 3 | Sphere | Can form a crystal ball with a firm |
| | | mouthfeel, remaining independent after |
| | | sterilization |
| Comparative | Cannot | Cannot form a crystal ball |
| Example 1 | form a | |
| | ball-shape | |
| Comparative | Sphere | Can form a crystal ball with a firm |
| Example 2 | | mouthfeel; the gel-ball has melted after |
| | | sterilization |
| Comparative | Sphere | Can form a crystal ball with a chewy |
| Example 3. | | mouthfeel; the gel-ball remain the original |
| | | shape but gel-balls integrate into a big |
| | | chunk and cannot be separated after |
| | | sterilization |

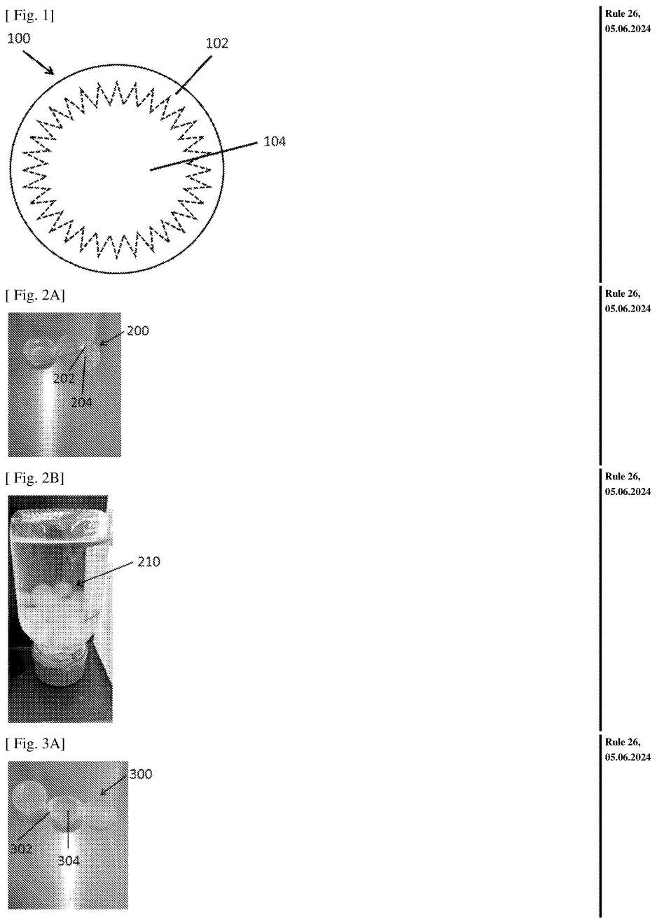

The appearance of the gel-ball of Example 1 before and after sterilization under 121° C. for 15 minutes is shown in FIGS. 2A and 2B, respectively. FIG. 2A shows that the gel-ball of Example 1 before sterilization was sliced into half and the cross section of the gel-ball was observed. The gel-ball 200 includes a surface 202 and a core 204. The surface 202 has slightly different color from the core 204. The outer ring of the surface 202 has a certain degree of difference from the inner ring of the surface 202 adjacent to the core 204 in terms of structure and components, and thus it looks like that the surface and the core form a tenon-and-mortise like structure. The surface 202 cannot be easily peeled from the core 204. The gel-ball 200 of Example 1 is a crystal ball with a soft mouthfeel. FIG. 2B shows that the gel-ball 210 maintains a ball shape structure and remains an independent ball after sterilization under 121° C. for 15 minutes.

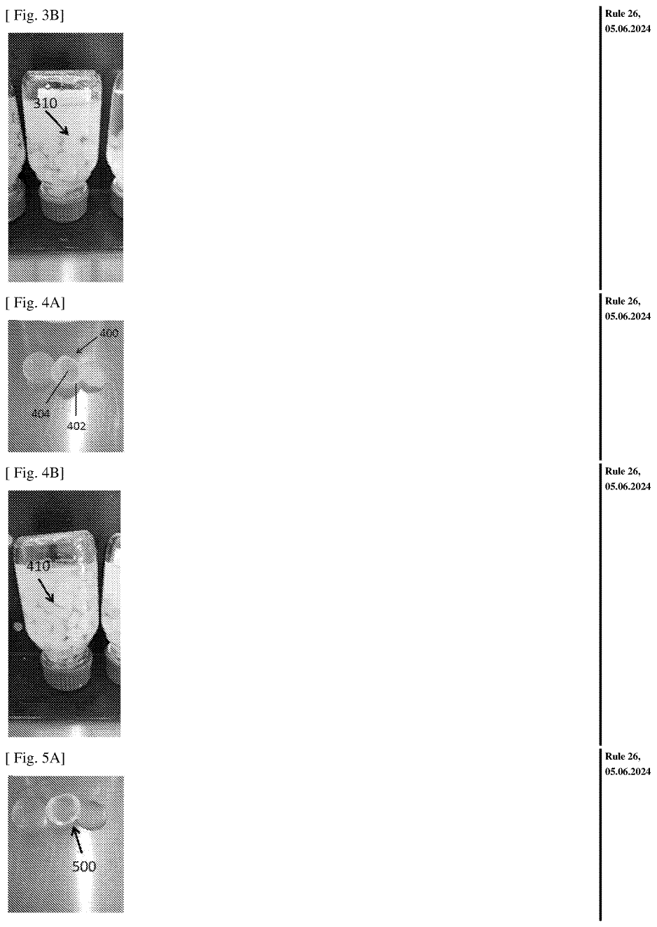

The appearance of the gel-ball of Example 2 before and after sterilization under 121° C. for 15 minutes is shown in FIGS. 3A and 3B, respectively. FIG. 3A shows that the gel-ball of Example 2 before sterilization was sliced into half and the cross section of the gel-ball was observed. The gel-ball 300 includes a surface 302 and a core 304. The surface 302 has slightly different color from the core 304. The outer ring of the surface 302 has a certain degree of difference from the inner ring of the surface 302 adjacent to the core 304 in terms of structure and components, and thus it looks like that the surface and the core form a tenon-and-mortise like structure. The surface 302 cannot be easily peeled from the core 304. The gel-ball 300 of Example 2 is a crystal ball with a chewy mouthfeel. FIG. 3B shows that the gel-ball 310 maintains a ball shape structure and remains an independent ball after sterilization under 121° C. for 15 minutes.

The appearance of the gel-ball of Example 3 before and after sterilization under 121° C. for 15 minutes is shown in FIGS. 4A and 4B, respectively. FIG. 4A shows that the gel-ball of Example 3 before sterilization was sliced into half and the cross section of the gel-ball was observed. The gel-ball 400 includes a surface 402 and a core 404. The surface 402 has slightly different color from the core 404. The outer ring of the surface 402 has a certain degree of difference from the inner ring of the surface 402 adjacent to the core 404 in terms of structure and components, and thus it looks like that the surface and the core form a tenon-and-mortise like structure. The surface 402 cannot be easily peeled from the core 404. The gel-ball 400 of Example 3 is a crystal ball with a firm mouthfeel. FIG. 4B shows that the gel-ball 410 maintains a ball shape structure and remains an independent ball after sterilization under 121° C. for 15 minutes.

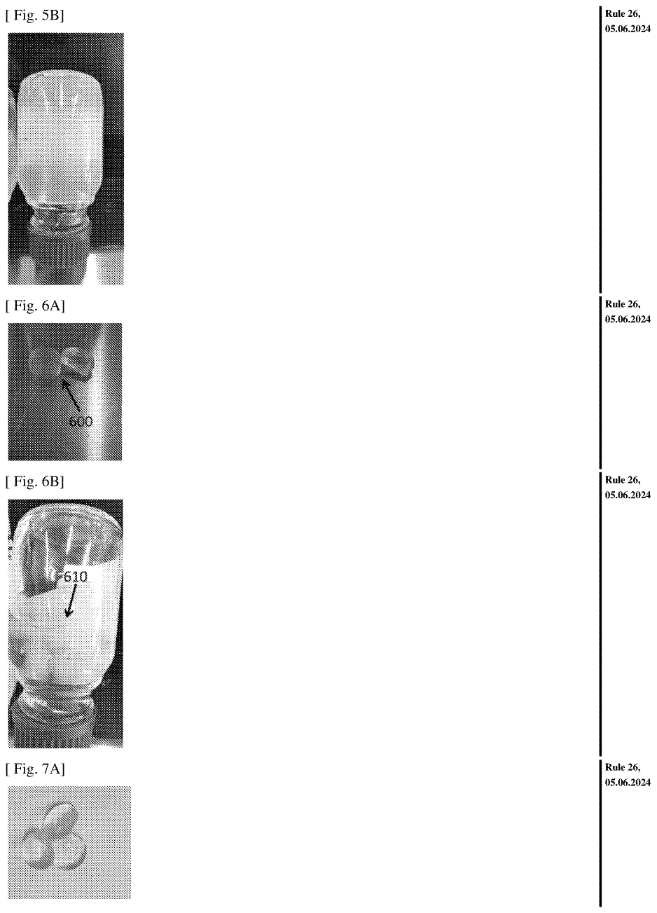

Comparative Example 1 (FIG. not shown) cannot form a ball shape. The appearance of the gel-ball of Comparative Example 2 before and after sterilization under 121° C. for 15 minutes is shown in FIGS. 5A and 5B, respectively. FIG. 5A shows that the gel-ball of Comparative Example 2 before sterilization was sliced into half and the cross section of the gel-ball was observed. The gel-ball 500 of Comparative Example 2 is a crystal ball with a firm mouthfeel. FIG. 5B shows that the gel-ball has melted after sterilization under 121° C. for 15 minutes and no gel-ball can be seen in the container after sterilization. The surface of gel-ball of Comparative Example 2 does not have sufficient compactness due to lack of heat preservation process or essential components and thus the gel-ball is not heat-resistant.

The appearance of the gel-ball of Comparative Example 3 before and after sterilization under 121° C. for 15 minutes is shown in FIGS. 6A and 6B, respectively. FIG. 6A shows that the gel-ball of Comparative Example 3 before sterilization was sliced into half and the cross section of the gel-ball was observed. The gel-ball 600 of Comparative Example 3 is a crystal ball with a chewy mouthfeel. FIG. 6B shows that the gel-ball 610 remains the original shape but the gel-balls integrate in a big chunk and cannot be separated after sterilization under 121° C. for 15 minutes. The surface of gel-ball of Comparative Example 3 does not have sufficient compactness due to lack of heat preservation process or essential components and thus the gel-ball is not heat-resistant.

Thus, it can be observed that the gel-balls obtained by the process of the present invention can resist the sterilization at 121° C. for 15 minutes without compromising the structure and integrity, while the gel-balls of the comparative examples cannot stand for such sterilization process and cannot maintain its original shape after sterilization.

### Example 4

### Preparation of Frozen Gel-Balls 1-3

The gel-balls of Examples 1-3 are placed in a freezer until they are frozen to obtain frozen gel-balls 1-3.

### Example 5

### Preparation of Frozen Gel-Balls 4-6

A first mixture was prepared according to the ingredients in Table 10. The first mixture was heated to the indicated temperature for the indicated period in Table 10. The powder ingredients are mixed first and then they are added into liquid ingredients (water and syrup). The mixture is blended and heated to a temperature around 90-95° C.

TABLE 10

| | Frozen | Frozen | Frozen |
|---|---|---|---|
| Ingredient | gel-ball 4 | gel-ball 5 | gel-ball 6 |
| Sodium | 0.40% | 0.40% | 0.40% |
| alginate | | | |
| Carrageenan | 0.55% | 0.55% | 0.55% |
| Konjac | 0.85% | 0.85% | 0.85% |
| Potassium | 0.40% | 0.40% | 0.40% |
| citrate | | | |
| Fructose and | 0% | 15.00% | 45.00% |
| glucose syrup | | | |
| (Glucose: | | | |
| 31.51% and | | | |
| Fructose: | | | |
| 42,35%) | | | |
| Cane sugar | 10.00% | 10.00% | 10.00% |
| Water | 87.80% | 72.80% | 42.80% |
| Total | 100.00% | 100.00% | 100.00% |
| Temperature: | 90-95° C. | 90-95° C. | 90-95° C. |
| Maintain | 15 mins | 15 mins | 15 mins |
| time: | | | |

A second mixture was prepared according to the ingredients in Table 11. The second mixture was heated to the indicated temperature in Table 11. Calcium lactate and optional sugar are added into water, and they are heated to the setting temperature at 60° C.

TABLE 11

| | Frozen | Frozen | Frozen |
|---|---|---|---|
| Ingredient | gel-ball 4 | gel-ball 5 | gel-ball 6 |
| Calcium lactate | 2.00% | 2.00% | 2.00% |
| Water | 98.00% | 98.00% | 98.00% |
| Total | 100% | 100% | 100% |
| Temperature | 60° C. | 60° C. | 60° C. |

The first mixture is added drop by drop to the second mixture and they are maintained for 5 minutes as shown in Table 12.

TABLE 12

| | Frozen | Frozen | Frozen |
|---|---|---|---|
| | gel-ball 4 | gel-ball 5 | gel-ball 6 |
| Temperature | 60° C. | 60° C. | 60° C. |
| Maintained time | 5 mins | 5 mins | 5 mins |

As described above, the gel-balls are then filtered and soaked in sugar water solution such as the third mixture. The gel-balls are sterilized for 15 minutes under a temperature of 121° C. The gel-balls are placed in a freezer until they are frozen to obtain frozen gel-balls.

### Example 6

Appearance of frozen gel-balls 4-6 is described in Table 13. The gel-ball was analyzed by a pressure test conducted on a Texture Analyser. The Texture Analyser is used in a compression/force test mode with a Pre-test speed of 0.5 mm/second. The deformation distance of a frozen gel-ball at a set force of 200 Newtons was determined. Pressure tests under a force of 200N are conducted onto the frozen gel-balls to determine the deformation distance/extent that the frozen gel-balls can take under the external force. Tapioca balls are purchased commercially from the market. Frozen gel-balls 4-6 and tapioca balls have similar sizes.

TABLE 13

| | Appearance | Pressure test |
|---|---|---|
| | (after frozen) | (200N): mm |
| Frozen gel-ball 4 | Frozen-resistant, | 1.65 |
| | a little hard, separated from | |
| | each other after frozen | |
| Frozen gel-ball 5 | Frozen-resistant, | 1.82 |
| | a little hard, separated from | |
| | each other after frozen | |
| Frozen gel-ball 6 | Frozen-resistant, | 3.03 |
| | keep soft, separated from | |
| | each other after frozen | |
| Frozen tapioca balls | Mouth feel: hard; | 0.825 |
| | Sticky and attached to each | |
| | other after frozen | |

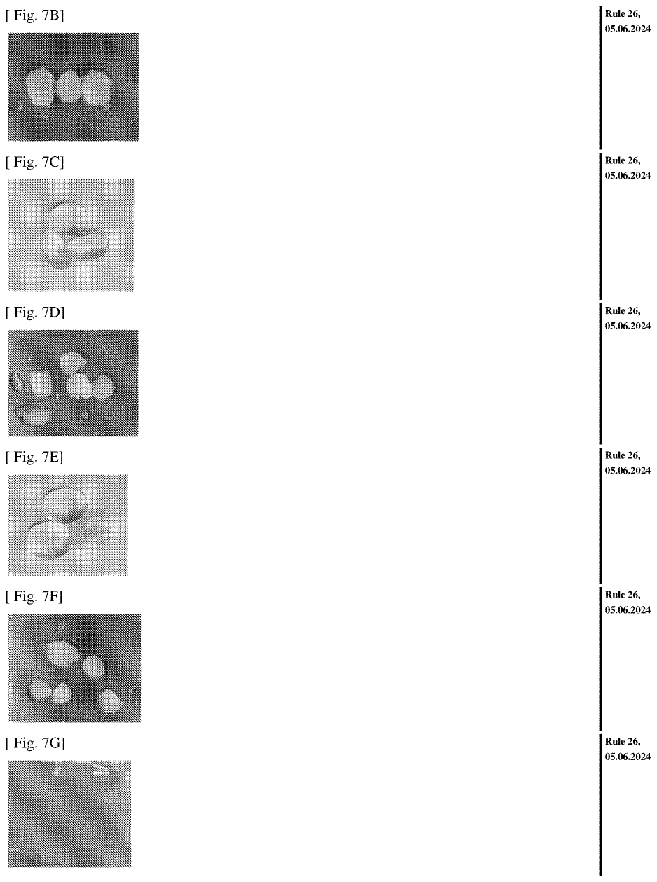

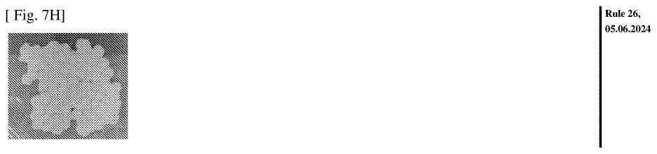

Frozen gel-balls 4-6 before and after frozen are shown in FIGS. 7A-7F, respectively. Tapioca balls before and after frozen are shown in FIGS. 7G and 7H, respectively.

Frozen gel-balls 1-3 are cold resistant (FIGS. not shown). Frozen gel-balls 4-6 are cold resistant, but tapioca balls are not. Frozen gel-balls 4-6 have a longer deformation distance than frozen tapioca balls when the pressure tests are conducted onto the balls, which indicates that frozen gel-balls 4-6 are more chewy and elastic than frozen tapioca balls.

The pressure tests demonstrate the elasticity of the frozen gel-balls even at cold temperatures. The appearance of the frozen gel-balls is different in the cold temperatures than the gel-balls before frozen as they are no longer transparent but are cloudy/milky in appearance. In contrast, the frozen tapioca-based gel balls are not chewy as the frozen gel-balls of the present invention when used in frozen application and do not have the elasticity and chewiness of gel balls that are cold-resistant. The appearance of the frozen tapioca gel balls is cloudy/milky similar to the frozen gel balls but the texture and elasticity are different.

Thus, frozen gel-balls 1-6 are more suitable to being used in frozen applications such as cold food or cold beverages than frozen tapioca balls.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

Representative features of the present invention are set out in the following clauses, which stand alone or may be combined, in any combination, with one or more features disclosed in the text of the Specification.

The present invention is as set out in the following clauses:

Clause 1. A frozen gel-ball suitable to be added to food, feed, beverage, cosmetic or pharmaceutical products, comprising a gelling agent, an alginate salt, a humectant, and a first sugar, preferably the frozen gel-ball is cold-resistant.

Clause 2. A frozen gel-ball suitable to be added to food, feed, beverage, cosmetic or pharmaceutical products, comprising:
a core comprising a core gel network comprising a gelling agent, an alginate salt and a humectant; and
a surface comprising a surface gel network comprising calcium alginate,
wherein the core gel network and the surface gel network intermingle with each other at the junction between the core and the surface, preferably the frozen gel-ball is cold-resistant.

Clause 3. The frozen gel-ball of clause 2, wherein the frozen gel-ball comprises a first sugar, and the first sugar is distributed in the core, or the surface or a combination thereof, and wherein the first sugar comprises cane sugar, glucose, fructose, lactose, maltose, glucose syrup, fructose and glucose syrup, corn syrup, invert sugar, honey, maple syrup, brown sugar, molasses or any combination thereof.

Clause 4. The frozen gel-ball of any one of the preceding clauses, wherein the frozen gel-ball is cold-resistant when exposed to a temperature of from 0° C. to −50° C., or from −10° C. to −20° C., or from 0° C. to −10° C., or from −12° C. to −18° C.

Clause 5. The frozen gel-ball of any one of the preceding clauses, wherein the gelling agent is carrageenan.

Clause 6. The frozen gel-ball of any one of the preceding clauses, wherein the humectant is konjac.

Clause 7. The frozen gel-ball of any one of the preceding clauses, wherein the alginate salt is sodium alginate.

Clause 8. The frozen gel-ball of any one of the clauses, wherein the gel-ball further comprises a potassium salt.

Clause 9. The frozen gel-ball of clause 8, wherein the potassium salt is potassium chloride or potassium citrate.

Clause 10. A process of manufacturing a frozen gel-ball suitable to be added to food, feed, beverage, cosmetic or pharmaceutical products, wherein the process includes:
providing a first mixture that includes 0.05-1 wt % of an alginate salt, 0.01-2 wt % of a gelling agent, 0.01-2 wt % of a humectant, 0.01-1 wt % of a potassium salt, 0-60 wt %, preferably 10-60 wt % of a first sugar, and 34-95 wt % of water;
heating the first mixture to 60-95° C., preferably 80-95° C. and maintaining the temperature of the first mixture;
providing a second mixture that includes 0.1-5 wt % of a calcium salt, 0-10 wt % of the first sugar, and 85-95 wt % of water;
heating the second mixture to 50-95° C., preferably 70-90° C. and maintaining the temperature of the second mixture;
adding the first mixture with the temperature of 60-95° C., preferably 80-95° C. maintained to the second mixture with the temperature of 50-95° C., preferably 70-90° C. maintained drop by drop to shape up a ball,
filtering the ball to obtain the gel-ball, and
freezing the gel-ball to obtain the frozen gel-ball,
wherein the first sugar in the first mixture and the first sugar in the second mixture are not zero at the same time, preferably the frozen gel-ball is cold-resistant.

Clause 11. The process of clause 10, wherein the first sugar comprises cane sugar, glucose, fructose, lactose, maltose, glucose syrup, fructose and glucose syrup, corn syrup, invert sugar, honey, maple syrup, brown sugar, molasses or any the combination thereof.

Clause 12. The process of any one of clauses 10-11, wherein the temperature of the first mixture is maintained for more than 10 minutes before adding to the second mixture.

Clause 13. The process of any one of clauses 10-12, wherein the temperature of the second mixture is maintained for 5-30 minutes, preferably 5-10 minutes before the first mixture is added to the second mixture.

Clause 14. The process of any one of any one of clauses 10-13, wherein the ball is maintained in the second mixture at 50-95° C., preferably 70-90° C. for 1-15 minutes, preferably 1-10 minutes before the ball is filtered.

Clause 15. The process of any one of clauses 10-14, wherein the calcium salt is calcium lactate or calcium chloride.

Clause 16. The process of any one of clauses 10-15, further comprising providing a third mixture that includes 0-2 wt % of acid regulator, 48-100 wt % of second sugar, and 0-50 wt % of water.

Clause 17. The process of any one of clause 16, wherein the acid regulator is citric acid.

Clause 18. The process of clause 16 or 17, wherein the second sugar comprises cane sugar, glucose, fructose, lactose, maltose, glucose syrup, fructose and glucose syrup, corn syrup, invert sugar, honey, maple syrup, brown sugar, molasses or any combination thereof, or preferably the second sugar comprises 1-50 wt % cane sugar and/or 1-80 wt % of fructose and glucose syrup.

Clause 19. The process of any one of clauses 16-18, further comprising heating the third mixture to a temperature of 50-95° C. and maintained the temperature of the third mixture, and adding the filtered ball to the third mixture with the temperature of 50-95° C. maintained.

Clause 20. The process of any one of clauses 10-19, wherein the gel-ball is sterilized for 5-15 minutes at a temperature of 95-121° C. prior to being frozen.

Clause 21. A frozen gel-ball obtained by the process of any one of clauses 10-20.

Clause 22. Use of the gel-ball as defined in any one of the preceding clauses in frozen application.

Clause 23. Use of the frozen gel-ball of any one of clauses 1-9 and 21 in food, feed, beverage, cosmetic or pharmaceutical products, preferably in cold food or cold beverage.

Clause 24. A gel-ball suitable to be added to food, feed, beverage, cosmetic or pharmaceutical products, comprising:
a core comprising a core gel network comprising a gelling agent, an alginate salt and a humectant; and
a surface comprising a surface gel network comprising calcium alginate,
wherein the core gel network and the surface gel network intermingle with each other at the junction between the core and the surface.

Clause 25. The gel-ball of clause 24, wherein the gel-ball maintains integrity when exposed to a temperature of 95-121° C.

Clause 26. The gel-ball of clauses 24 or 25, wherein the gel-ball maintains integrity when exposed to a temperature of 95-121° C. for 5 to 15 minutes.

Clause 27. The gel-ball of any one of clauses 24 or 26, wherein the gelling agent is carrageenan.

Clause 28. The gel-ball of any one of clauses 24 or 27, wherein the humectant is konjac.

Clause 29. The gel-ball of any one of clauses 24 or 28, wherein the alginate salt is sodium alginate.

Clause 30. The gel-ball of any one of clauses 24 or 29, wherein the gel-ball further comprises a potassium salt.

Clause 31. The gel-ball of clauses 30, wherein the potassium salt is potassium chloride or potassium citrate.

Clause 32. A process of manufacturing a gel-ball suitable to be added to food, feed, beverage, cosmetic or pharmaceutical products, wherein the process includes:
providing a first mixture that includes 0.05-1 wt % of an alginate salt, 0.01-2 wt % of a gelling agent, 0.01-2 wt % of a humectant, 0.01-1 wt % of a potassium salt, and 80-95 wt % of water;
heating the first mixture to 60-95° C., preferably 80-95° C. and maintaining the temperature of the first mixture;
providing a second mixture that includes 0.1-5 wt % of a calcium salt, 1-10 wt % of a first sugar, and 85-95 wt % of water;
heating the second mixture to 50-95° C., preferably 70-90° C. and maintaining the temperature of the second mixture;
adding the first mixture with the temperature of 60-95° C., preferably 80-95° C. maintained to the second mixture with the temperature of 50-95° C., preferably 70-90° C. maintained drop by drop to shape up a ball, and
filtering the ball to obtain the gel-ball.

Clause 33. The process of clause 32, wherein the temperature of the first mixture is maintained for more than 10 minutes before adding to the second mixture.

Clause 34. The process of clause 33, wherein the temperature of the second mixture is maintained for 5-30 minutes, preferably 5-10 minutes before the first mixture is added to the second mixture.

Clause 35. The process of any one of clauses 32-34, wherein the ball is maintained in the second mixture at 50-95° C., preferably 70-90° C. for 1-15 minutes, preferably 1-10 minutes before the ball is filtered.

Clause 36. The process of any one of clauses 32-35, wherein the calcium salt is calcium lactate or calcium chloride.

Clause 37. The process of any one of clauses 32-36, further comprising providing a third mixture that includes 0-2 wt % of acid regulator, 48-100 wt % of second sugar, and 0-50 wt % of water.

Clause 38. The process of any one of clause 37, wherein the acid regulator is citric acid.

Clause 39. The process of clause 37 or 38, wherein the second sugar contains 1-50 wt % cane sugar and/or 1-80 wt % of fructose and glucose syrup.

Clause 40. The process of any one of clauses 37-39, further comprising heating the third mixture to a temperature of 50-95° C. and maintained the temperature of the third mixture, and adding the filtered ball to the third mixture with the temperature of 50-95° C. maintained.

Clause 41. The process of any one of clauses 32-40, wherein the gel-ball is sterilized for 5-15 minutes at a temperature of 95-121° C.

Clause 42. A gel-ball obtained by the process of any one of clauses 32-41.

1. A gel-ball suitable to be added to food, feed, beverage, cosmetic or pharmaceutical products, comprising:
a core comprising a core gel network comprising a gelling agent, an alginate salt and a humectant; and
a surface comprising a surface gel network comprising calcium alginate,
wherein the core gel network and the surface gel network intermingle with each other at the junction between the core and the surface.

2. The gel-ball of claim 1, wherein the gel-ball maintains integrity when exposed to a temperature of 95-121° C., preferably when exposed to a temperature of 95-121° C., for 5 to 15 minutes.

3. The gel-ball of claim 1, wherein the gel-ball is cold-resistant when exposed to a temperature of from 0° C. to −50° C.

4. The gel-ball of claim 1, wherein the gelling agent is carrageenan.

5. The gel-ball of claim 1, wherein the humectant is konjac.

6. The gel-ball of claim 1, wherein the alginate salt is sodium alginate.

7. The gel-ball of claim 1, wherein the gel-ball further comprises a potassium salt.

8. (canceled)

9. A process of manufacturing a gel-ball suitable to be added to food, feed, beverage, cosmetic or pharmaceutical products, wherein the process includes:
providing a first mixture comprising 0.05-1 wt % of an alginate salt, 0.01-2 wt % of a gelling agent, 0.01-2 wt % of a humectant, 0.01-1 wt % of a potassium salt, and 80-95 wt % of water;
heating the first mixture to 60-95° C. and maintaining the temperature of the first mixture between 60-95° C.;
providing a second mixture comprising 0.1-5 wt % of a calcium salt, 1-10 wt % of a first sugar, and 85-95 wt % of water;
heating the second mixture to 50-95° C. and maintaining the temperature of the second mixture between 50-95° C.;
adding the first mixture to the second mixture drop by drop to form a ball, and
filtering the ball to obtain the gel-ball.

10. The process of claim 9, wherein the temperature of the first mixture is maintained for more than 10 minutes before adding to the second mixture.

11. The process of claim 10, wherein the temperature of the second mixture is maintained for 5-30 minutes, preferably 5-10 minutes before the first mixture is added to the second mixture.

12. The process of claim 9, wherein the ball is maintained in the second mixture at 50-95° C., for 1-15 minutes before the ball is filtered.

13. The process of claim 9, wherein the calcium salt is calcium lactate or calcium chloride.

14. The process of claim 9, further comprising providing a third mixture comprising 0-2 wt % of acid regulator, 48-100 wt % of second sugar, and 0-50 wt % of water.

15. (canceled)

16. The process of claim 9, wherein the second sugar contains 1-50 wt % cane sugar and/or 1-80 wt % of fructose and glucose syrup.

17. The process of claim 9, further comprising heating the third mixture to a temperature of 50-95° C. and maintained the temperature of the third mixture and adding the filtered ball to the third mixture with the temperature of 50-95° C. maintained.

18. The process of claim 9, wherein the gel-ball is sterilized for 5-15 minutes at a temperature of 95-121° C.

19. A gel-ball obtained by the process of claim 9.

20. (canceled)

21. A frozen gel-ball suitable to be added to food, feed, beverage, cosmetic or pharmaceutical products, comprising:
a core comprising a core gel network comprising a gelling agent, an alginate salt and a humectant; and
a surface comprising a surface gel network comprising calcium alginate,
wherein the core gel network and the surface gel network intermingle with each other at the junction between the core and the surface, wherein the frozen gel-ball is cold-resistant.

22. The frozen gel-ball of claim 21, wherein the frozen gel-ball comprises a first sugar, and the first sugar is distributed in the core, or the surface or a combination thereof, and wherein the first sugar comprises cane sugar, glucose, fructose, lactose, maltose, glucose syrup, fructose and glucose syrup, corn syrup, invert sugar, honey, maple syrup, brown sugar, molasses or any combination thereof.

23. The frozen gel-ball of claim 21, wherein the frozen gel-ball is cold-resistant when exposed to a temperature of from 0° C. to −50° C., or from −10° C. to −20° C., or from 0° C. to −10° C., or from −12° C. to −18° C.

24-29. (canceled)
